(19) United States
(12) Patent Application Publication
(10) Pub. No.: US 2026/0223857 A1
(43) Pub. Date: Aug. 6, 2026

(54) METHOD FOR CONTROLLING CHESTNUT BLIGHT BASED ON FOSETYL-ALUMINIUM AS IMMUNOACTIVATOR MIXED WITH BIOCONTROL BACTERIUM FERMENTATION FILTRATE

(71) Applicant: Zhejiang A&F University, Hangzhou (CN)

(72) Inventors: Kai Guo, Hangzhou (CN); Shuai Wang, Hangzhou (CN); Guo'an Luo, Hangzhou (CN); Yongming Zheng, Hangzhou (CN); Anliang Chen, Hangzhou (CN); Xiu Su, Hangzhou (CN); Jiafu Hu, Hangzhou (CN)

(21) Appl. No.: 19/431,716

(22) Filed: Dec. 23, 2025

(30) Foreign Application Priority Data
Dec. 25, 2024 (CN) 202411926562.9

(51) Int. Cl. A01N 63/22; A01N 57/12; A01P 3/00

(52) U.S. Cl. CPC A01N 63/22; A01N 57/12; A01P 3/00

(57) ABSTRACT

This application relates to a method for controlling chestnut blight using fosetyl-aluminium as an immunoactivator combined with a fermentation filtrate of Bacillus velezensis B268. The method includes culturing Cryphonectria parasitica, preparing PDA media containing different concentrations of fosetyl-aluminium and diluted B268 fermentation filtrate, and performing indoor antifungal assays. Chestnut seedlings are divided into control groups and treatment groups receiving fosetyl-aluminium, the fermentation filtrate, or their mixture. Based on antifungal results, effective concentrations are sprayed onto leaves and trunks, followed by in vitro and in vivo inoculation. Leaf samples collected at multiple time points are used to determine defense enzyme activities and malondialdehyde content, with transcriptome sequencing performed on selected samples. The combined use of fosetyl-aluminium and B268 fermentation filtrate enhances plant resistance and provides synergistic disease-control efficacy, reducing chemical pesticide usage while improving overall control effectiveness.

### CROSS REFERENCE TO RELATED APPLICATION

This patent application claims the benefit and priority of Chinese Patent Application No. 2024119265629, filed with the China National Intellectual Property Administration on Dec. 25, 2024, the disclosure of which is incorporated by reference herein in its entirety as part of the present application.

### TECHNICAL FIELD OF THE INVENTION

The present disclosure provides a method for controlling chestnut blight based on fosetyl-aluminium as an immunoactivator mixed with a biocontrol bacterium fermentation filtrate, relating to the technical field of plant protection.

### BACKGROUND OF THE INVENTION

Chestnut blight is a fungal disease primarily caused by Cryphonectria parasitica. This disease severely damages the main trunks and branches of chestnut trees and can sometimes affect leaves as well. In the initial stage, numerous circular or irregular lesions appear on the branches, ranging in color from reddish-brown to purplish-brown. The lesions are slightly raised, become sunken and dry when desiccated, develop shrinkage cracks, and are densely covered with small orange-yellow or brown granules. The disease generally occurs on the main trunk or primary branches approximately one meter above ground level. Initially, water-soaked spots appear on the affected parts, gradually expanding to encircle the trunk, leading to wet rot of the tissues and possible exudation of brown fluid. As the condition worsens, the lesions darken in color, and may cause the bark to dry, shrink, and develop longitudinal cracks, eventually leading to death. Leaves on infected trunks or branches become smaller and yellow, and buds fail to sprout while leaves turn brown and wither in severe cases.

As a systemic organophosphorus fungicide with bidirectional translocation, fosetyl-aluminium exhibits a fungicidal effect that is manifested in the ability to inhibit spore germination or impede the formation of mycelia and spores after entering the plant body. Moreover, phosphates as metabolites of the fosetyl-aluminium can stimulate pathogens to release elicitors that induce the synthesis of phytoalexins. Furthermore, upon pathogen invasion, the fosetyl-aluminium enables plants to rapidly synthesize and accumulate flavonoid-like phytoalexins, thereby significantly enhancing the plant resistance to pathogens.

Bacillus velezensis B268: Strain B268 was isolated from a rhizosphere soil sample (Na⁺ content: 7.119 mg per gram of dry soil) of a Casuarina equisetifolia coastal shelter forest in Yueqing City, Zhejiang Province, with a deposition number of CGMCC No. 13225. Using a polyphasic taxonomic approach, B268 was identified as a novel lineage within the Bacillus velezensis species group. Studies have found that B268 exhibits optimal growth at 3% (W/V) NaCl, with a growth range of 0% to 15% (W/V) NaCl. The antifungal activity of B268 was determined via viable cell counting and the plate confrontation method. This strain demonstrates antagonistic activity against nine tested pathogenic fungi, indicating its potential for research and development in the biological control of plant salinity stress and diseases.

Currently, the primary methods for controlling chestnut blight include chemical and biological control. Chemical control mainly involves spraying fungicides, but long-term use can lead to pathogen resistance and environmental pollution, while affecting the quality of chestnuts. Biological control primarily utilizes antagonistic microorganisms or their metabolites to manage diseases, offering advantages such as environmental friendliness and safety. However, the efficacy is often inferior to that of chemical control.

Therefore, a method for controlling chestnut blight based on fosetyl-aluminium as an immunoactivator mixed with a biocontrol bacterium fermentation filtrate is proposed in the present disclosure.

### BRIEF SUMMARY OF THE INVENTION

An objective of the present disclosure is to address the problems existing in the background by proposing a method for controlling chestnut blight based on fosetyl-aluminium as an immunoactivator mixed with a biocontrol bacterium fermentation filtrate.

To achieve the above objective, the present disclosure provides the following technical solutions: The present disclosure provides a method for controlling chestnut blight based on fosetyl-aluminium as an immunoactivator mixed with a biocontrol bacterium fermentation filtrate, including the following steps: step 1, culturing Cryphonectria parasitica using a potato dextrose agar (PDA) medium and preparing fungal discs using a puncher; step 2, preparing PDA media using fosetyl-aluminium solutions at different concentrations and Bacillus velezensis B268 fermentation filtrates diluted to different multiples, transferring the fungal discs onto the PDA media to allow incubation, and conducting mycelial growth inhibition assay on PDA medium; step 3, selecting chestnut seedlings, establishing two control groups and three treatment groups of the chestnut seedlings, including: a positive control group (spraying with sterile water and inoculating with the Cryphonectria parasitica), a negative control group (spraying with the sterile water and inoculating with sterile PDA), a fosetyl-aluminium treatment group, a B268 fermentation filtrate treatment group, and a fosetyl-aluminium+B268 fermentation filtrate treatment group; collecting and preserving leaves from the chestnut seedlings in each of the groups without any chemical spray on day 0 to allow an assay of defense enzyme activities and a malondialdehyde (MDA) content; step 4, based on results obtained from the step 2, uniformly spraying the leaves and trunks of the chestnut seedlings in the three treatment groups at concentrations demonstrating a superior indoor antifungal efficacy, where the fosetyl-aluminium+B268 fermentation filtrate treatment group requires mixing by preparing a fosetyl-aluminium solution and adding a B268 fermentation filtrate at a specific volume calculated based on a volume of the fosetyl-aluminium solution; conducting in vitro inoculation and in vivo inoculation three days later, respectively; and step 5: collecting and properly preserving leaf samples from each group periodically on days 0, 2, 4, 8, and 16 to allow the assay of the defense enzyme activities and the MDA content, and selecting a part of the samples on day 8 to allow transcriptome sequencing analysis.

Depository authority is: China General Microbiological Culture Collection Center (CGMCC); depository address is: No. 3, Courtyard 1, Beichen West Road, Chaoyang District, Beijing; accession number is: CGMCC No. 13225; taxonomic designation is: Bacillus siamensis. This biological material (strain) was received by the CGMCC on Nov. 1, 2016, and was registered.

Preferably, the Bacillus velezensis B268 is isolated from rhizosphere soil of a Casuarina equisetifolia coastal shelter forest, and has a deposition number of CGMCC No. 13225; and a process for preparing a stock solution of the Bacillus velezensis B268 fermentation filtrates includes: inoculating a single colony of the Bacillus velezensis B268 into a test tube containing 4 mL of YTGB medium (containing 0.05% of Yeast extract, 0.5% of Trypticase peptone, 1% of Glucose, and 0.3% of Beef extract powder, and having a pH value of 7.0), conducting incubation at 28° C. and 140 rpm for 24 h to prepare a seed culture; taking 1% of the seed culture to allow expanded cultivation for 48 h to obtain a fermentation broth; and subjecting the fermentation broth to centrifugal separation and filtering an obtained supernatant through a 0.22 μm membrane filter to obtain the stock solution of the Bacillus velezensis B268 fermentation filtrates.

Preferably, a process for preparing fosetyl-aluminium water-soluble granules for trunk injection includes: preparing raw materials including fosetyl-aluminium technical material with a purity of 95% and an adjuvant, where the adjuvant includes alkyl polyglycoside with a purity of 50%, dodecyl betaine, gum arabic as a binder, and ammonium sulfate as a filler; and subjecting the raw materials to mixing, crushing, mixing with water, granulation, and drying.

Preferably, 85% to 87% of the fosetyl-aluminium technical material, 2% to 5% of the alkyl polyglycoside, 2% to 5% of the dodecyl betaine, 1% to 5% of the gum arabic, and 5% to 10% of the ammonium sulfate are uniformly mixed; a resulting mixture is crushed to obtain a crushed material with a fineness less than 23 μm; the crushed material is mixed with water accounting for 7% of a total weight of the crushed material; a resulting aqueous mixture is subjected to extrusion granulation using a screw extrusion granulator; and resulting granules are dried using a vibrating fluidized bed dryer at a gas phase temperature less than 120° C. to obtain dried granules as the fosetyl-aluminium water-soluble granules for trunk injection having a moisture content less than 0.6%.

Preferably, the mycelial growth inhibition assay on PDA medium includes: serially diluting the fosetyl-aluminium technical material with sterile water to a required concentration, adding a corresponding volume of an obtained drug solution according to a total volume of the PDA medium, and preparing PDA media using fosetyl-aluminium at different concentrations, specifically 0.1 mg/L, 1 mg/L, 10 mg/L, 100 mg/L, and 200 mg/L, thereby obtaining a treatment group; preparing a control group receiving an equal amount of sterile water in the PDA medium, subjecting the treatment group and the control group to inoculation with the Cryphonectria parasitica; conducting incubation under illumination at 28° C.; when a mycelium in the control group covers ¾ of the PDA medium, evaluating an inhibition effect via a mycelial growth rate method and calculating a median effective concentration (EC₅₀) value; subjecting the PDA media prepared by diluting a stock solution of the Bacillus velezensis B268 fermentation filtrates with the PDA medium to 5-fold, 10-fold, 20-fold, 40-fold, and 80-fold dilutions, as well as a control group not receiving any solution in the PDA medium, to inoculation with the Cryphonectria parasitica; conducting incubation under illumination at 28° C.; when the mycelium in the control group covers ¾ of the PDA medium, determining the inhibition effect via the mycelial growth rate method and calculating the EC₅₀ value.

Preferably, the assay of the defense enzyme activities includes: quantifying functional activities of catalase (CAT), superoxide dismutase (SOD), and peroxidase (POD).

Preferably, the in vitro inoculation involves harvesting leaves from each of the groups to allow an indoor in vitro inoculation assay, and the indoor in vitro inoculation assay includes: wrapping vein ends of the leaves with sterile cotton to achieve moisture retention, marking a 5 mm measurement zone at a midrib position of each leaf using a vernier caliper, scratching the measurement zone with a sterilized blade to form a leaf wound, taking a three-day-old Cryphonectria parasitica culture, preparing fungal discs of the Cryphonectria parasitica culture using a 5 mm puncher, placing the fungal discs with a mycelial side closely attached to the leaf wound, and placing the leaves in a sterile incubation box with filter paper soaked in the sterile water at a box bottom to allow moist incubation.

Preferably, the in vivo inoculation includes: creating a hole on a tree trunk using a 7 mm puncher, removing a phloem tissue at the hole on the tree trunk, taking a three-day-old Cryphonectria parasitica culture, preparing fungal discs of the Cryphonectria parasitica culture using a 7 mm puncher, attaching the fungal discs with a mycelial side to xylem of the tree trunk, wrapping the hole with a parafilm to achieve moisture retention; and subjecting a tree trunk of the negative control group to inoculation with a PDA medium not containing the Cryphonectria parasitica culture.

Compared with the prior art, the present disclosure has the following beneficial effects:

In the present disclosure, the method involves a binary combination of Bacillus velezensis B268 and fosetyl-aluminium. The resulting bactericidal mixture, within a specific mass ratio range, exhibits a synergistic effect in controlling chestnut blight.

Significant Disease Control Efficacy: The method can effectively enhance the resistance of chestnut trees to chestnut blight, reduce the occurrence and expansion of lesions, and demonstrates superior disease control efficacy compared with traditional biological control methods.

In the present disclosure, a resulting bactericidal composition obtained by the method simultaneously utilizes a combination of disease-resistant function from the biological agent and an immune-activating function from the fosetyl-aluminium. The combination enhances disease control efficacy on the plant internally and externally. Furthermore, an ecological model is achieved through the combination, thereby reducing the application rate while increasing effectiveness.

In the present disclosure, the mixture of fosetyl-aluminium and Bacillus velezensis B268 fermentation filtrates can improve the antifungal capability of the control agent while activating the plant's inherent immune function. This reduces the application rate of chemical pesticides, leveraging both the disease resistance-inducing function of fosetyl-aluminium and the antifungal efficacy of the Bacillus velezensis B268 fermentation filtrates. The combined use enhances the overall disease control efficacy.

### BRIEF DESCRIPTION OF THE DRAWINGS

FIG. 1 is a schematic flowchart according to the present disclosure.

FIG. 2 shows photographs of the inhibitory effect of the Bacillus velezensis B268 fermentation filtrates in the present disclosure on Cryphonectria parasitica on a PDA medium.

FIG. 3 shows a histogram of the inhibitory effect of the Bacillus velezensis B268 fermentation filtrates in the present disclosure on Cryphonectria parasitica on a PDA medium.

### DETAILED DESCRIPTION OF THE INVENTION

The technical solutions of the examples of the present disclosure are clearly and completely described below with reference to the drawings in the examples of the present disclosure. Apparently, the described examples are merely a part rather than all of the embodiments of the present disclosure. All other examples obtained by those skilled in the art based on the examples of the present disclosure without creative efforts shall fall within the protection scope of the present disclosure.

### Example 1

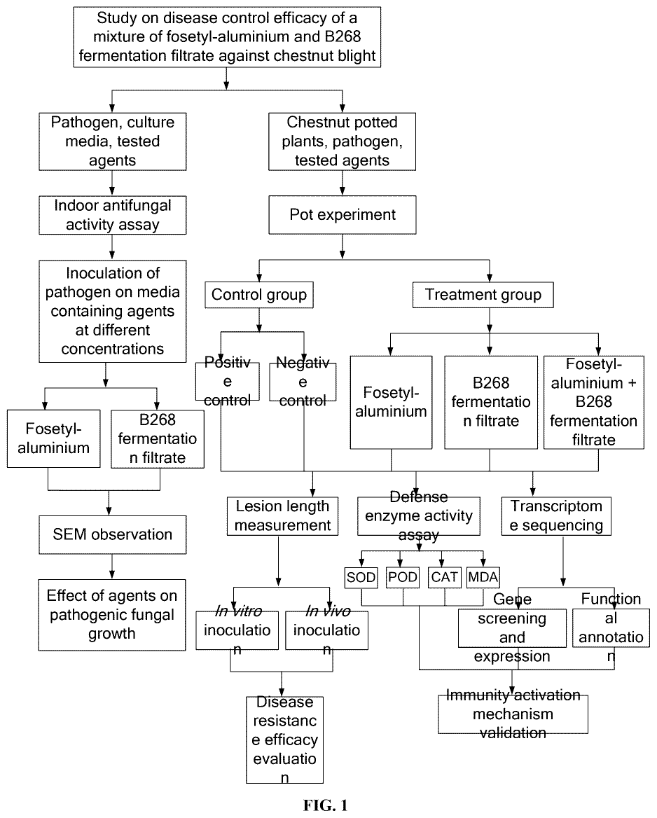

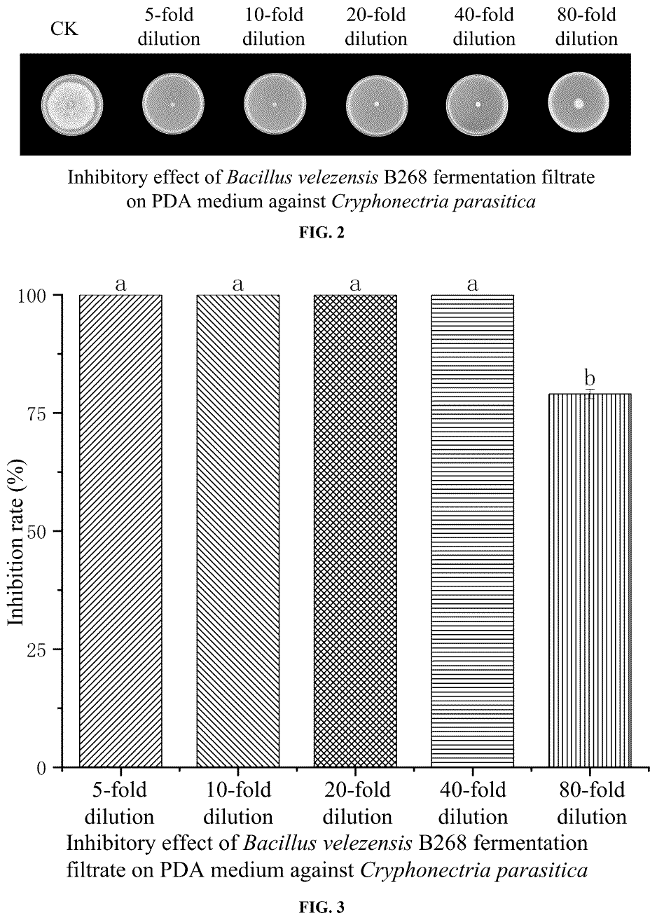

As shown in FIG. 1 to FIG. 3, a method for controlling chestnut blight based on fosetyl-aluminium as an immunoactivator mixed with a biocontrol bacterium fermentation filtrate, as proposed by the present disclosure, included the following steps:

The Bacillus velezensis B268 was isolated from a rhizosphere soil sample of a Casuarina equisetifolia coastal shelter forest, with a deposition number of CGMCC No. 13225. A process for preparing the Bacillus velezensis B268 fermentation filtrates involved picking a single colony from an LB medium inoculated with the B268 strain and transferring it into a test tube containing 4 mL of YTGB medium (including (W/V): Yeast extract (BD) 0.05%, Trypticase peptone (BD) 0.5%, Glucose 1%, and Beef extract powder 0.3%, pH=7.0). This was incubated at 28° C. and 140 rpm for 24 h to prepare a seed culture. Then, 1% of the seed culture was taken for expanded cultivation for 48 h to obtain a fermentation broth. After centrifugation of the fermentation broth, a resulting supernatant was filtered through a 0.22 μm membrane to obtain the Bacillus velezensis B268 fermentation filtrates.

A process for preparing fosetyl-aluminium water-soluble granules for trunk injection involved preparation of raw materials: fosetyl-aluminium technical material with 95% purity and an adjuvant. The adjuvant included alkyl polyglycoside with 50% purity, dodecyl betaine, gum arabic as a binder, and ammonium sulfate as a filler, followed by mixing, crushing, mixing with water, granulation, and drying. Specifically, 85% to 87% of the fosetyl-aluminium technical material, 2% to 5% of the alkyl polyglycoside, 2% to 5% of the dodecyl betaine, 1% to 5% of the gum arabic, and 5% to 10% of the ammonium sulfate were uniformly mixed; a resulting mixture was crushed to obtain a crushed material with a fineness less than 23 μm; the crushed material was mixed with water accounting for 7% of a total weight of the crushed material; a resulting aqueous mixture was subjected to extrusion granulation using a screw extrusion granulator; and resulting granules were dried using a vibrating fluidized bed dryer at a gas phase temperature less than 120° C. to obtain dried granules as the fosetyl-aluminium water-soluble granules for trunk injection having a moisture content less than 0.6%.

Step 1: The Cryphonectria parasitica as a pathogen was incubated on a PDA medium for 3 d. Under aseptic conditions, fungal discs were made using a 5 mm sterile puncher from the actively growing mycelial edges of the incubated pathogen colonies.

Step 2: PDA media were prepared using fosetyl-aluminium solutions at different concentrations and by diluting the Bacillus velezensis B268 fermentation filtrates to different multiples, and were then inoculated with the Cryphonectria parasitica for incubation.

Subsequently, mycelial growth inhibition assay on PDA medium was conducted, with the steps as follows:

PDA media were prepared using fosetyl-aluminium at concentrations of 0.1 mg/L, 1 mg/L, 10 mg/L, 100 mg/L, and 200 mg/L and inoculated with Cryphonectria parasitica. A stock solution of the Bacillus velezensis B268 fermentation filtrates were diluted with the PDA medium to prepare PDA media at 5-fold, 10-fold, 20-fold, 40-fold, and 80-fold dilutions. An equal amount of sterile water was added to a control medium. All media were inoculated with Cryphonectria parasitica and incubated under illumination at 28° C. When the mycelium in the control group covered ¾ of the PDA medium, the inhibitory effect was determined using the mycelial growth rate method, and the EC₅₀ value was calculated.

The specific implementation methods were as follows:

### Fosetyl-Aluminium Group:

An appropriate amount of fosetyl-aluminium technical material was weighed and gradient-diluted with sterile water to prepare fosetyl-aluminium solutions at 0.1 mg/L, 1 mg/L, 10 mg/L, 100 mg/L, and 200 mg/L, respectively.

An appropriate amount of potato dextrose agar (PDA) powder was weighed, distilled water was added according to the instruction ratio, and the mixture was heated to dissolve. The dissolved PDA medium was dispensed into sterile culture dishes, approximately 15 mL to 20 mL per dish. When the PDA medium was cooled to 50° C. to 60° C., the different concentrations of fosetyl-aluminium solution were added separately and thoroughly mixed.

Cryphonectria parasitica was inoculated onto the PDA media containing different concentrations of fosetyl-aluminium, with 5 replicates for each concentration. An equal amount of sterile water was added to the control group.

Bacillus velezensis B268 Fermentation Filtrate Group:

The PDA medium was prepared according to its formulation and made up to the same volume. After sterilization, it was allowed to cool to 50° C. to 60° C.

A stock solution of the Bacillus velezensis B268 fermentation filtrates were added to the PDA medium according to corresponding factors to obtain PDA media diluted to 5-fold, 10-fold, 20-fold, 40-fold, and 80-fold dilutions, respectively, and set aside.

The PDA media containing the Bacillus velezensis B268 fermentation filtrates were poured into culture dishes, approximately 15 mL to 20 mL per dish, with 5 replicates for each concentration. The control group did not receive any added solution.

After the prepared media were inoculated with fungal discs of the pathogen:

The culture dishes were placed in an incubator at 28° C. under illumination for incubation.

Mycelial growth was observed daily. When the mycelium in the control group covered ¾ of the medium, the colony diameters of each treatment group were measured.

A ruler or vernier caliper was used to measure the colony growth diameter of each treatment group.

The mycelial growth rate for each treatment group was calculated (colony diameter/incubation days).

The mycelial growth inhibition rate for each treatment group was calculated using the following formula: Inhibition Rate (%)=(Control Colony Diameter−Treatment Colony Diameter)/(Control Colony Diameter−Fungal Disc Diameter)×100%.

The EC₅₀ value refers to the concentration of fermentation filtrate required to inhibit mycelial growth by 50%. Statistical software SPSS was then used for data processing to determine the EC₅₀ value. Through the above steps, the concentrations of the fosetyl-aluminium solutions and the Bacillus velezensis B268 fermentation filtrates demonstrating better indoor antifungal efficacy could be calculated.

Step 3: Chestnut seedlings with consistent age and growth vigor were selected. Two control groups were established: a positive control group and a negative control group. Three treatment groups were established: a fosetyl-aluminium treatment group, a B268 fermentation filtrate treatment group, and a fosetyl-aluminium+B268 fermentation filtrate treatment group. Leaves were collected and preserved for the assay of defense enzyme activities and MDA content before any chemical spray was applied on day 0.

Step 4: Based on the results from the step 2, concentrations demonstrating better indoor antifungal efficacy were used as the spraying concentrations. The three treatment groups including the fosetyl-aluminium treatment group, the B268 fermentation filtrate treatment group, and the fosetyl-aluminium+B268 fermentation filtrate treatment group were uniformly sprayed on the leaf surfaces and trunks with their respective concentration solutions. For the fosetyl-aluminium+B268 fermentation filtrate treatment group, mixing was required. The mixing involved preparing a fosetyl-aluminium solution and adding a B268 fermentation filtrate at a specific volume calculated based on a volume of the fosetyl-aluminium solution to obtain the mixed agent at the target concentration. In vitro inoculation and in vivo inoculation were conducted separately three days later.

The specific steps for the in vitro inoculation were as follows:

Three days later, leaves were collected from each group (the positive control group, the fosetyl-aluminium treatment group, the B268 fermentation filtrate treatment group, and the fosetyl-aluminium+B268 fermentation filtrate treatment group).

The main vein ends of the collected leaves were wrapped with sterile cotton to maintain leaf moisture. A 5 mm zone on the midrib of the leaf was measured using a vernier caliper and marked with a marker pen.

The marked 5 mm zone on the leaf was gently wounded using a sterilized blade to expose the wound site.

Using the fungal discs prepared in Step 1, a disc was taken and placed with its mycelial side facing down onto the wounded site of the leaf, ensuring close contact between the disc and the wound.

The inoculated leaves were placed in a sterile incubation box with moistened sterile filter paper at the bottom for humidified cultivation.

The growth of the pathogen on the leaves was observed periodically, and data such as the expansion speed and disease severity of the pathogen were recorded.

A method for calculating leaf disease severity was as follows:

At regular intervals after inoculation (24 h, 48 h, 72 h), the growth of the pathogen on the leaves was observed, assisted by a magnifying glass or microscope, and the mycelial expansion was recorded.

Pictures were taken with a camera or mobile phone to document the disease progression on the leaves for further analysis. The diameter or area of the pathogen at each inoculation point was recorded.

Based on the extent of pathogen expansion on the leaves, the disease severity could be classified into several grades:
Grade 0: No lesion;
Grade 1: Lesion diameter less than 1 mm;
Grade 3: Lesion diameter of 1 mm to 2 mm;
Grade 5: Lesion diameter of 2 mm to 5 mm; and
Grade 7: Lesion diameter greater than 5 mm.

The disease index is a quantitative indicator reflecting the severity of the disease, calculated using the following formula:

$$Disease Index = \frac{\sum ( Grade \times Number )}{Total number of leaves \times ( Maximum grade )} \times 100$$

Data from the leaves of each group were collected.

Based on the calculation results, the disease index for each group was obtained.

According to the disease index of the in vitro leaves, a lower disease index indicates milder disease in the plant, while a higher disease index indicates more severe disease. This allowed for the determination of the impact of different control and treatment groups on the growth and incidence of chestnut blight, demonstrating a synergistic effect between the fosetyl-aluminium and the Bacillus velezensis B268 fermentation filtrates.

The specific steps for the in vivo inoculation were as follows:

Three days later, chestnut seedlings from each group (the positive control group, the fosetyl-aluminium treatment group, the B268 fermentation filtrate treatment group, and the fosetyl-aluminium+B268 fermentation filtrate treatment group) were prepared.

A 7 mm puncher, parafilm, sterile PDA medium, and the pathogen were prepared. A 7 mm puncher was used to create a hole on the surface of the tree trunk to a depth sufficient to remove the phloem tissue at the hole and expose the xylem, ensuring that the hole was clean and free of debris.

Using the fungal discs prepared in the step 1, a disc was placed with its mycelial side facing into the hole on the trunk xylem. The disc was pressed gently to ensure close contact between the mycelia and the xylem.

The inoculation site was wrapped and sealed with the parafilm to maintain humidity and promote pathogen growth.

On another set of trees, holes were created using the same method, and sterile PDA medium was inoculated as a negative control, following the same steps as for pathogen inoculation.

After inoculation, the reaction at the inoculation site was observed and recorded periodically, such as the formation and expansion of lesions, and differences among the various treatment groups were recorded. The specific observation methods were as follows:

Transparent gridded film was placed over the lesion to count the number of grids covered by the lesion and estimate the lesion area.

Professional image software Adobe Photoshop was used to measure the lesion area.

Based on the proportion of the lesion area relative to the total area of the inoculation site, disease severity grades were assigned:
No lesion: Grade 0
Lesion area≤5%: Grade 1;
5%<Lesion area≤10%: Grade 3;
10%<Lesion area≤20%: Grade 5; and
Lesion area>20%: Grade 7.

Data on trunk lesions from each control group were collected and calculated using the disease index formula.

Based on the calculation results, the disease indices for the two control groups were obtained.

According to the disease index of the trunk lesions, a lower disease index indicates milder disease in the plant, while a higher disease index indicates more severe disease. This allowed for the determination of the impact of different control groups on the growth and incidence of chestnut blight, demonstrating a synergistic effect between the fosetyl-aluminium and the Bacillus velezensis B268 fermentation filtrates.

Step 5: At 0, 2, 4, 8, and 16 d after the start of the assay, sterile scissors, forceps, and pre-labeled sterile sampling bags were prepared. Leaves with consistent growth were randomly selected from the plants in each group and cut off using the sterile scissors.

The cut leaves were placed into the sterile sampling bags and labeled accordingly (including group designation, inoculation time, and sampling time).

The sampling bags were flash-frozen in liquid nitrogen and stored in a −80° C. freezer.

At this point, leaf samples stored at −80° C. from the step 3 and from days 0, 2, 4, 8, and 16 of the step 5 were retrieved for analysis:

### Catalase (CAT) Activity Assay:

Plant tissue was first mixed with a phosphate-buffered saline (PBS, pH=7.0-7.4) and homogenized in an ice bath.

The homogenate was then centrifuged at 12,000 g at 4° C., and the supernatant was collected for enzyme activity assay.

A reaction mixture was prepared in test tubes, including 50 mM phosphate buffer, 10 mM H₂O₂ solution, and the enzyme extract.

The reaction was initiated by adding H₂O₂, and the decomposition of H₂O₂ was recorded. The reaction was terminated using an ammonium sulfate solution.

Finally, the decrease in H₂O₂ was measured spectrophotometrically to calculate CAT activity. Superoxide Dismutase (SOD) Activity Assay:

Plant tissue was taken and a proportional amount of PBS (pH=7.0-7.4) was added, followed by grinding into a homogenate in an ice bath.

The nitroblue tetrazolium (NBT) photoreduction method was used. The reaction mixture included: 50 mM PBS (pH=7.8), 13 mM methionine, 75 μM NBT, 0.1 mM EDTA, 2 μM riboflavin, and the enzyme extract.

The reaction mixture was placed under a fluorescent lamp for a light-induced reaction.

Immediately after light exposure, the reaction was terminated by placing the samples in the dark.

Absorbance at 560 nm was measured to calculate SOD activity.

### Peroxidase (POD) Activity Assay:

Plant tissue was first mixed with PBS (pH=7.0-7.4) and homogenized in an ice bath.

Next, a reaction mixture was prepared including 25 mM PBS, 20 mM guaiacol, 5% H₂O₂, and the enzyme extract.

The reaction was initiated by adding H₂O₂, and the change in absorbance was recorded at 470 nm using a spectrophotometer to calculate POD activity.

### Malondialdehyde (MDA) Content Assay:

Plant tissue was first mixed with PBS (pH 7.0-7.4) and homogenized in an ice bath.

Then, an aliquot of the homogenate supernatant was mixed with an equal volume of 20% trichloroacetic acid (TCA) solution. After mixing, the sample was centrifuged at 12,000 g for 10 min at 4° C.

Next, the supernatant was mixed with an equal volume of 0.6% thiobarbituric acid (TBA) solution, heated in a boiling water bath for 15 min, rapidly cooled, and centrifuged.

Finally, the MDA content was determined by measuring absorbance at wavelengths of 532 nm and 600 nm.

Based on the calculation results from the above assays, the impact of treatments from the different control and treatment groups on the levels of CAT, SOD, POD, and MDA within the plants was determined.

On day 8, transcriptome sequencing was conducted on the leaf samples.

Data analysis was conducted on the sequencing data to better understand the influence of the fosetyl-aluminium+B268 fermentation filtrate treatment on gene expression differences in chestnut trees before and after treatment.

Comparison with the control groups showed that the fosetyl-aluminium+B268 fermentation filtrate treatment group exhibited a superior disease control efficacy.

Based on the evaluation of disease control efficacy using the above methods, a synergistic effect of mixing the fosetyl-aluminium solution with the Bacillus velezensis B268 fermentation filtrates was demonstrated. This approach is therefore applicable to the method for controlling chestnut blight based on fosetyl-aluminium as an immunoactivator mixed with a biocontrol bacterium fermentation filtrate.

The above specific examples are merely several preferred examples of the present disclosure. Based on the technical solutions of the present disclosure and the related teachings of the above examples, those skilled in the art can make various alternative improvements and combinations to the above specific examples.

It is apparent for those skilled in the art that the present disclosure is not limited to details of the above exemplary embodiments, and that the present disclosure may be implemented in other specific forms without departing from spirit or basic features of the present disclosure. Accordingly, the embodiments should be regarded in all points of view as exemplary and not restrictive, and the scope of the present disclosure is defined by the appended claims rather than the above description. Therefore, all changes falling within the meaning and scope of equivalent elements of the claims should be included in the present disclosure.

What is claimed is:

1. A method for controlling chestnut blight based on fosetyl-aluminium as an immunoactivator mixed with a biocontrol bacterium fermentation filtrate, comprising following steps: step 1, culturing Cryphonectria parasitica using a potato dextrose agar (PDA) medium and preparing fungal discs using a puncher; step 2, preparing PDA media using fosetyl-aluminium solutions at different concentrations and Bacillus velezensis B268 fermentation filtrates diluted to different multiples, transferring the fungal discs onto the PDA media to allow incubation, and conducting mycelial growth inhibition assay on PDA medium; step 3, selecting chestnut seedlings, establishing two control groups and three treatment groups of the chestnut seedlings, comprising: a positive control group (spraying with sterile water and inoculating with the Cryphonectria parasitica), a negative control group (spraying with the sterile water and inoculating with sterile PDA), a fosetyl-aluminium treatment group, a B268 fermentation filtrate treatment group, and a fosetyl-aluminium+B268 fermentation filtrate treatment group; collecting and preserving leaves from the chestnut seedlings in each of the groups without any chemical spray on day 0 to allow an assay of defense enzyme activities and a malondialdehyde (MDA) content; step 4, based on results obtained from the step 2, uniformly spraying the leaves and trunks of the chestnut seedlings in the three treatment groups at concentrations demonstrating a superior indoor antifungal efficacy, wherein the fosetyl-aluminium+B268 fermentation filtrate treatment group requires mixing by preparing a fosetyl-aluminium solution and adding a B268 fermentation filtrate at a specific volume calculated based on a volume of the fosetyl-aluminium solution; conducting in vitro inoculation and in vivo inoculation three days later, respectively; and step 5: collecting and properly preserving leaf samples from each group periodically on days 0, 2, 4, 8, and 16 to allow the assay of the defense enzyme activities and the MDA content, and selecting a part of the samples on day 8 to allow transcriptome sequencing analysis.

2. The method for controlling chestnut blight based on fosetyl-aluminium as an immunoactivator mixed with a biocontrol bacterium fermentation filtrate according to claim 1, wherein the Bacillus velezensis B268 is isolated from rhizosphere soil of a Casuarina equisetifolia coastal shelter forest, and has a deposition number of CGMCC No. 13225; and a process for preparing a stock solution of the Bacillus velezensis B268 fermentation filtrates comprises: inoculating a single colony of the Bacillus velezensis B268 into a test tube containing 4 mL of YTGB medium that contains 0.05% of Yeast extract, 0.5% of Trypticase peptone, 1% of Glucose, and 0.3% of Beef extract powder, and has a pH value of 7.0, conducting incubation at 28° C. and 140 rpm for 24 h to prepare a seed culture; taking 1% of the seed culture to allow expanded cultivation for 48 h to obtain a fermentation broth; and subjecting the fermentation broth to centrifugal separation and filtering an obtained supernatant through a 0.22 μm membrane filter to obtain the stock solution of the Bacillus velezensis B268 fermentation filtrates.

3. The method for controlling chestnut blight based on fosetyl-aluminium as an immunoactivator mixed with a biocontrol bacterium fermentation filtrate according to claim 1, wherein a process for preparing fosetyl-aluminium water-soluble granules for trunk injection comprises: preparing raw materials comprising fosetyl-aluminium technical material with a purity of 95% and an adjuvant, wherein the adjuvant comprises alkyl polyglycoside with a purity of 50%, dodecyl betaine, gum arabic as a binder, and ammonium sulfate as a filler; and subjecting the raw materials to mixing, crushing, mixing with water, granulation, and drying.

4. The method for controlling chestnut blight based on fosetyl-aluminium as an immunoactivator mixed with a biocontrol bacterium fermentation filtrate according to claim 3, wherein 85% to 87% of the fosetyl-aluminium technical material, 2% to 5% of the alkyl polyglycoside, 2% to 5% of the dodecyl betaine, 1% to 5% of the gum arabic, and 5% to 10% of the ammonium sulfate are uniformly mixed; a resulting mixture is crushed to obtain a crushed material with a fineness less than 23 μm; the crushed material is mixed with water accounting for 7% of a total weight of the crushed material; a resulting aqueous mixture is subjected to extrusion granulation using a screw extrusion granulator; and resulting granules are dried using a vibrating fluidized bed dryer at a gas phase temperature less than 120° C. to obtain dried granules as the fosetyl-aluminium water-soluble granules for trunk injection having a moisture content less than 0.6%.

5. The method for controlling chestnut blight based on fosetyl-aluminium as an immunoactivator mixed with a biocontrol bacterium fermentation filtrate according to claim 1, wherein the mycelial growth inhibition assay on PDA medium comprises: subjecting the PDA media containing the fosetyl-aluminium at 0.1 mg/L, 1 mg/L, 10 mg/L, 100 mg/L, and 200 mg/L, as well as a control group receiving an equal amount of sterile water in the PDA medium, to inoculation with the Cryphonectria parasitica; conducting incubation under illumination at 28° C.; when a mycelium in the control group covers ¾ of the PDA medium, evaluating an inhibition effect via a mycelial growth rate method and calculating a median effective concentration (EC₅₀) value; subjecting the PDA media prepared by diluting a stock solution of the Bacillus velezensis B268 fermentation filtrates with the PDA medium to 5-fold, 10-fold, 20-fold, 40-fold, and 80-fold dilutions, as well as a control group not receiving any solution in the PDA medium, to inoculation with the Cryphonectria parasitica; conducting incubation under illumination at 28° C.; when the mycelium in the control group covers ¾ of the PDA medium, determining the inhibition effect via the mycelial growth rate method and calculating the EC₅₀ value.

6. The method for controlling chestnut blight based on fosetyl-aluminium as an immunoactivator mixed with a biocontrol bacterium fermentation filtrate according to claim 1, wherein the assay of the defense enzyme activities comprises: quantifying functional activities of catalase (CAT), superoxide dismutase (SOD), and peroxidase (POD).

7. The method for controlling chestnut blight based on fosetyl-aluminium as an immunoactivator mixed with a biocontrol bacterium fermentation filtrate according to claim 1, wherein the in vitro inoculation involves harvesting leaves from each of the groups to allow an indoor in vitro inoculation assay, and the indoor in vitro inoculation assay comprises: wrapping vein ends of the leaves with sterile cotton to achieve moisture retention, marking a 5 mm measurement zone at a midrib position of each leaf using a vernier caliper, scratching the measurement zone with a sterilized blade to form a leaf wound, taking a three-day-old Cryphonectria parasitica culture, preparing fungal discs of the Cryphonectria parasitica culture using a 5 mm puncher, placing the fungal discs with a mycelial side closely attached to the leaf wound, and placing the leaves in a sterile incubation box with filter paper soaked in the sterile water at a box bottom to allow moist incubation.

8. The method for controlling chestnut blight based on fosetyl-aluminium as an immunoactivator mixed with a biocontrol bacterium fermentation filtrate according to claim 1, wherein the in vivo inoculation comprises: creating a hole on a tree trunk using a 7 mm puncher, removing a phloem tissue at the hole on the tree trunk, taking a three-day-old Cryphonectria parasitica culture, preparing fungal discs of the Cryphonectria parasitica culture using a 7 mm puncher, attaching the fungal discs with a mycelial side to xylem of the tree trunk, wrapping the hole with a parafilm to achieve moisture retention; and subjecting a tree trunk of the negative control group to inoculation with a PDA medium not containing the Cryphonectria parasitica culture.
